(19) United States
(12) Patent Application Publication
(10) Pub. No.: US 2003/0061062 A1
(43) Pub. Date: Mar. 27, 2003

(54) XML data switch

(76) Inventor: Timothy J. Tucker, Broomfield, CO (US)

Correspondence Address: The Law Offices of William W. Cochran, LLC, Suite 230, 3555 Stanford Road, Fort Collins, CO, 80525, US

(21) Appl. No.: 10/082,739

(22) Filed: Feb. 22, 2002

Related U.S. Application Data
(60) Provisional application No. 60/325,423, filed on Sep. 26, 2001.

(51) Int. Cl. G06F 17/60

(52) U.S. Cl. 705/1

(57) ABSTRACT

Disclosed is a data switch capable of transforming data from a first language and syntax to a second language and syntax. The data switch can be used in a server configuration wherein all transformation of data is performed by a server computer, or a relocatable transformation module may be placed on a client computer, enabling the client to perform some or all of the necessary transformation locally. Additionally, new and unique methods for calculating fees and generating revenue are embodied in the data switch. The data switch has fault tolerant features wherein the completion of each transaction is guaranteed.

### CROSS REFERENCE TO RELATED APPLICATIONS

This application is based upon and claims priority to U.S. provisional application No. 60/325,423 entitled “XML DATA SWITCH” filed Sep. 26, 2001 by Timothy Tucker. The entire disclosure of the referenced application is specifically incorporated herein by reference for all that they disclose and teach.

### BACKGROUND OF THE INVENTION

a. Field of the Invention

The present invention pertains generally to data transfer and specifically to data transfer between disparate software applications.

b. Description of the Background

Many software packages exist for various business applications, such as purchasing systems, planning systems, inventory, accounting, and other applications. These systems may be separate, stand alone packages in some applications, or integrated systems. One company may prefer a certain software package, while another may use a different software package.

In the traditional course of business, a simple purchasing transaction may involve several interactions, including requests for a quote and delivery date, the issuance of a purchase order, and the shipment of the product. Other interactions may also occur, including status of the order, particulars about shipping, current inventory levels, and other information as necessary. During these many interactions, there may be a human intervention required by both companies.

It has become more common for companies to interact electronically to speed up the business transactions. For example, a first company may make a portion of their inventory available to a second company over the internet. The second company may be able to check inventory and place orders without having to directly contact a person at the first company.

The difficulty arises when the first company and second company have different computer systems. The information required by each system may be slightly different and the formats may also be different, making file transfers incompatible.

Within a specific company, there are also many software systems that may use the same data or different aspects of the same data. For example, an inventory system may account for the supply of a certain raw material, while a purchasing system may use the rate of consumption of the raw material for forecasting the purchase. When the two systems are not integrated, data may be entered manually or the data may be otherwise transported between systems in many different fashions, such as a custom translator.

Data portability in the modern world of commerce is becoming seen as critical to business success. Of even greater importance is application interoperability. Being able to move data from one application to another, or from one company to another, allows companies to conduct business quickly and efficiently. In some cases, the savings by eliminating data entry and automating processes such as order entry can substantially affect a company's bottom line. By using the same data in multiple places, errors due to miscommunication may be eliminated, and changes to data can be propagated through various software applications that use the data. The limiting factor with current technologies is that such interconnectivity between different functions is generally only available to large, fully integrated enterprise software applications. If everyone is running software specifically designed to interact, data portability is theoretically achieved. Such is not the case when different companies with different software systems wish to interact.

It would therefore be advantageous to provide a system and method for providing interoperability between disparate software systems, including a system and method for conducting business based upon offering such interoperability services.

### SUMMARY OF THE INVENTION

The present invention overcomes the disadvantages and limitations of the prior art by providing a mechanism whereby disparate software applications may communicate through an XML Data Switch, or XDS. The main function of the XDS is to translate data from one vocabulary to a second vocabulary or multiple vocabularies. In addition, the XDS may provide matching communication protocols, data transport, security, billing, and additional features. XDS may use XML and XSL technology to achieve part of the translation, however, other functions may also be defined to convert data.

The XDS may be composed of three main sections, a rules engine, a translation engine, and a process engine. The rules engine establishes the parameters for each transaction. The translation engine processes the data from one vocabulary to a second vocabulary. The process engine handles data transport and other processes as may be required to complete the transaction.

The XDS may have two types of transformation modules: a resident transformation module and a relocatable transformation module. A resident transformation module may reside on a central server, such as on a server at an application service provider (ASP). A relocatable transformation module may comprise all or a portion of the transformation functionality that is moved to a client. In this manner, the client may perform some or all of the transformation before the data is moved to the server for processing, lightening the load on the server.

The XDS may have a state engine to ensure the success and completeness of each transaction. As each transaction is processed through the XDS, semaphores or other methods of tracking the progress of the transaction through the XDS may be maintained. In this manner, the transaction may be recovered and completed even in the event of an emergency shutdown and restart.

The present invention may therefore comprise a method for transforming and transporting financial transaction data between a first computer system and a second computer system comprising: transforming the data using a first client application on the first computer system; preparing a transaction, the transaction comprising the data, the preparation comprising encrypting the data; transporting the transaction to a server computer; processing the data on the server computer, the processing comprising decrypting the data, logging the transaction, and transforming the data, the processing further comprising determining the value of the financial transaction and multiplying the value by a percentage to calculate a fee; preparing the transaction, the preparation comprising encrypting the data; transporting the transaction to the second computer system; processing the transaction on the second computer system using a client application, the processing comprising decrypting the data; and transforming the data using the client application.

The present invention may further comprise a method of computing a fee for a transformation service performed on a financial transaction comprising: receiving a transaction from a first client computer system by a server computer system, the transaction comprising data to be transformed, the data comprising at least one financial transaction; transforming the data on the server computer system; processing the data to determine a value of the financial transaction and multiplying the value by a percentage to determine a fee for the transformation, the processing being performed on the server computer system; and transporting the data to a second client computer system.

The present invention may further comprise a data switch system for the transformation of a transaction comprising: a first client computer system having a first client application and being connected to a communications network and capable of transmitting a transaction, the first client application being capable of transforming the transaction at least partially with respect to a first schema; a server computer connected to the communications network, the server computer being capable of receiving and sending the transaction, the server being further capable of transforming the transaction at least partially with respect to a second schema; and a second client computer system having a second client application and being connected to a communications network and capable of receiving the transaction, the second client application being capable of transforming the transaction at least partially with respect to a third schema.

The advantages of the present invention are that disparate computer systems can interchange data seamlessly. The data interchange may take place between different companies wishing to transact business, or may take place between different functions within a single company. A data interchange service may be operated for profit by collecting revenues based on the value of the financial transactions handled by the data switch. Several features may be incorporated into the data switch, including making the switch to be fault tolerant so that each transaction is guaranteed to be completed.

### BRIEF DESCRIPTION OF THE DRAWINGS

In the drawings,

FIG. 1 is an illustration of a generic use of the inventive XML Data Switch.

FIG. 2 is an illustration of an embodiment of the present invention wherein a first company communicates with a second company.

FIG. 3 is an illustration of an embodiment of the present invention wherein a first company communicates with several companies.

FIG. 4 is a work flow diagram of an embodiment of the present invention.

FIG. 5 is a work flow diagram of an embodiment of the present invention wherein the flow of a transaction is shown through the XML Data Switch.

FIG. 6 is a work flow diagram of an embodiment of the present invention illustrating the relocatable transformation engines.

FIG. 7 is an illustration of an embodiment of the present invention showing a method for tracking the state of a transaction through the XDS for the purposes of error recovery and restarting the system.

FIG. 8 is a work flow diagram of an embodiment of the present invention wherein a transaction is processed through the XDS from one company to another.

FIG. 9 is a work flow diagram of an embodiment of the present invention wherein a transaction is processed through the XDS from one company to several companies and back again.

### DETAILED DESCRIPTION OF THE INVENTION

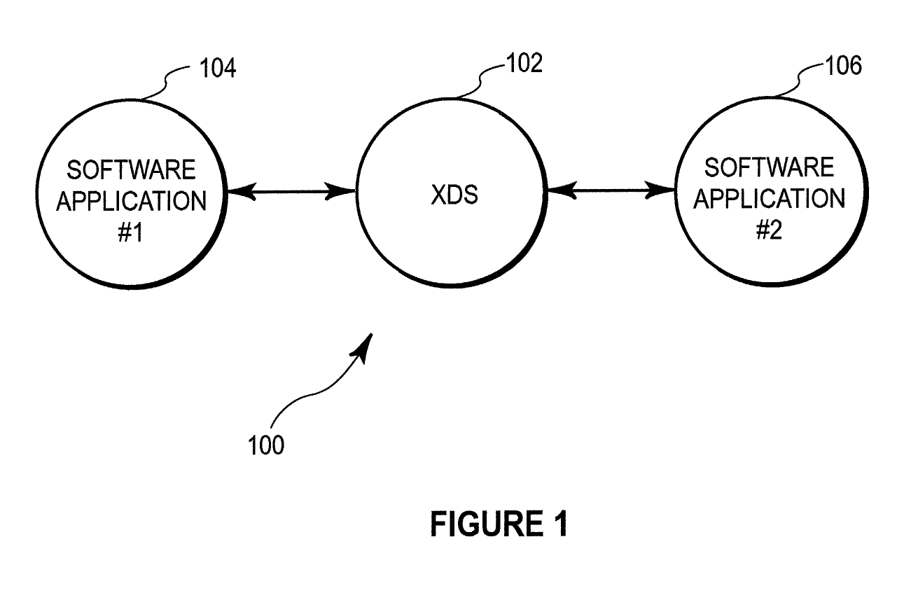

FIG. 1 illustrates a generic use 100 of the inventive XML Data Switch, or XDS 102. In the present case, a first software application 104 communicates bidirectionally to the XDS 102, which communicates bidirectionally to a second software application 106.

The first software application 104 and second software application 106 may be similar applications, but have different data formats. For example, the two software applications may be purchasing systems for two different organizations within a large corporation. Each purchasing system may be supplied by a different vendor and may be suited to the particular needs of each organization. In order to combine the buying power of the whole corporation, some data may be shared between the purchasing systems. The two purchasing systems are likely to have very similar types of data, and the translation from one system to another may only comprise the correct mapping of one field to another, plus the proper file structure and formatting.

In another example, the two software applications may be different applications that may share the same data. For example, a planning and scheduling program may create a bill of materials that may be used by an accounting program for billing. The bill of materials may be in a particular format and for use in the scheduling program, but that same information may also be useful in the accounting program. However, the types of data are likely to be much different from each other, and may require processing in addition to mapping of fields from one application to the other.

The software application 104 and software application 106 may reside within a single computer, in different computers within a single company, or between two companies. In the example of a single computer, the XDS may take data from one computer program and translate directly to a second program. In the example of different computers within a single company, the computers may be connected by a local area network (LAN) and the XDS may reside on a server computer that is connected to the LAN.

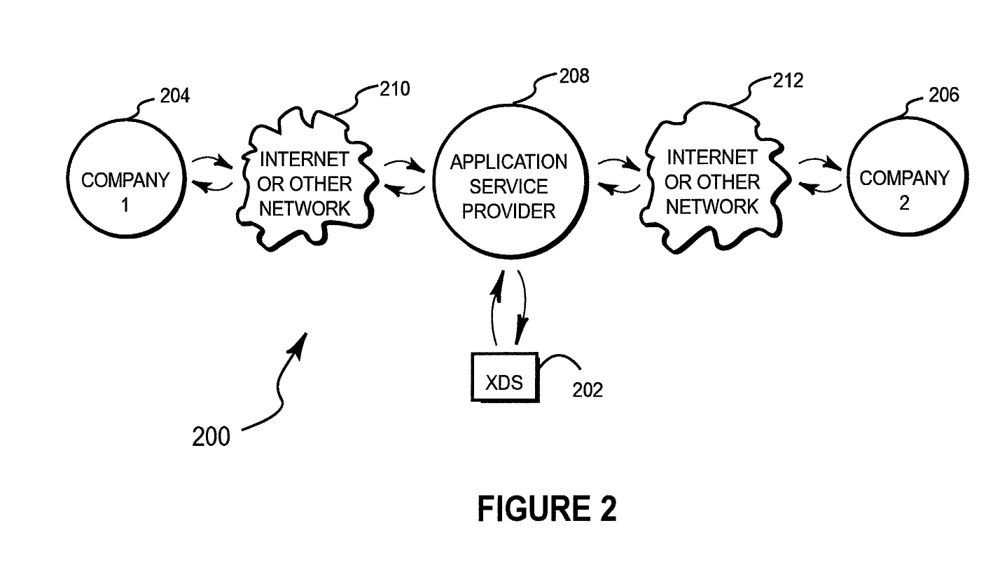

FIG. 2 illustrates an example of a use model 200 for XDS 202, wherein a first company 204 wishes to communicate with a second company 206. An application service provider (ASP) 208 hosting XDS 202 connects to the first company 204 through the Internet or other network 210 and likewise connects to the second company 206 through the Internet or other network 212.

In the use model 200, the ASP 208 may be a third company who provides the translation and communication services between the first company 204 and second company 206. The ASP may provide such services on a flat fee basis, on a per use basis, on a per dollar volume basis, or on any other accounting method negotiated between the companies.

The ASP 208 may connect to first company 204 through the Internet or other network 210. Alternatively, the Internet or network 210 may comprise any type of communications protocol or transmission methods, such as dedicated transmission lines, satellite communications, and microwave transmissions. The communications protocol may include human intervention methods such as fax transmittal.

The ASP 208 may connect to second company 206 through the Internet or other network 212. The Internet or network 212 may be the same communications network as network 210 or the network 212 may be a different network.

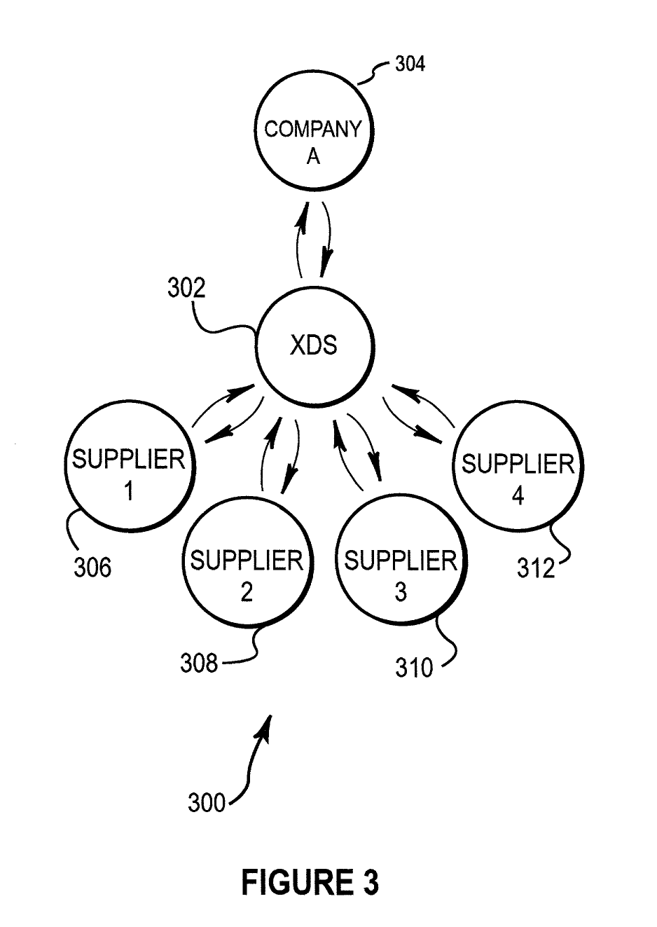

FIG. 3 illustrates an example of a use model 300 for XDS 302, wherein a first company 304 wishes to communicate with several other companies 306, 308, 310, and 312. In this case, the first company 304 may be a distributor of goods, such as electronic components. Each company 306, 308, 310, and 312 maybe suppliers to the first company 304. The first company 304 may be running an order processing system from a first vendor and each other company 306, 308, 310, and 312 may likewise each be using order processing systems from different vendors. XDS 302 allows the first company 304 to conduct business with many different companies without regard to compatibility between computer systems.

The benefits to the first company 304 for using XDS 302 are that the ability to add suppliers is not dependent on the logistics of working out the differences between computer systems, which had been a difficult and challenging task. Further, the XDS 302 provides a common interface for company 304, regardless if the several suppliers are each using different and heretofore incompatible systems. Rather than building a special translator between a new supplier, the first company 304 may only require that the new supplier make its data available to the XDS 302 that will handle the translations.

Embodiment 300 may be configured so that the supplier companies 306, 308, 310, and 312 are all able to receive and transact requests for orders. In such a case, the first company 304 may issue a request for price and availability of a certain item supplied by the supplier companies 306, 308, 310, and 312. The transaction maybe sent to the XDS 302 and simultaneously sent to all supplier companies 306, 308, 310, and 312. Each supplier company may respond to the request of the first company 304. The XDS 302 may consolidate the replies into one response report, which is then transmitted back to the first company 304. In some embodiments, individual reports may be sent to company 304 from each of the supplying companies.

When the XDS 302 is used to consolidate information from several different companies, the user who requested a quote may not be aware of the companies who may respond to the request. It would be incumbent on each supplier company to interface to the XDS 302 in order to do business with the first company 304. In such a model, XDS 302 acts as a business portal, providing a single source for transaction information for the first company 304, as well as a common interface for several supplying companies 306, 308, 310, and 312.

The XDS portal may be configured as a seamless integration of disparate software systems. In an example, the user of SAP software in the first company may request quotes from within SAP, quotes will be generated by several companies, each of which is using a different software system, and the quotes will be consolidated and sent back to the first company to be read and acted upon with the SAP software. The user of the SAP software that initiated the quote would have no knowledge that the supplier companies have a different software system.

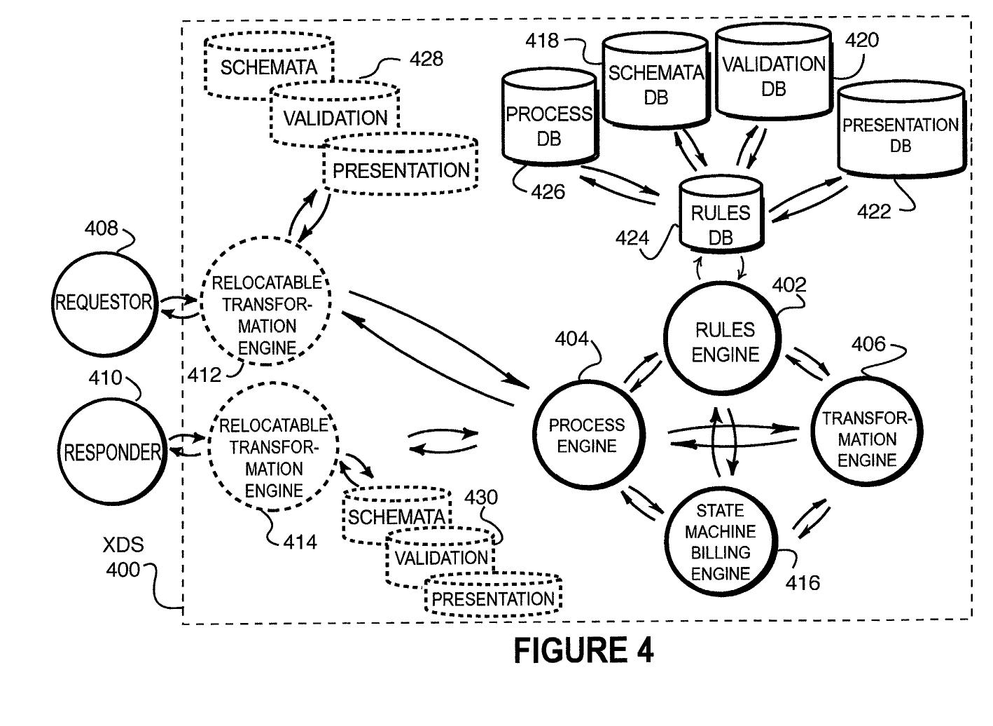

FIG. 4 illustrates the work flow of an embodiment 400 of the inventive XDS. The main components of the embodiment 400 are the rules engine 402, the process engine 404, and the transformation engine 406. The requester 408 and the responder 410 represent the computer systems that interface to the XDS embodiment 400. Both the requester 408 and responder 410 interface to the process engine 404, and may do so through optional relocatable transformation engines 412 and 414, respectively. The process engine 404 communicates with the rules engine 402 to get the appropriate information concerning a transaction. The process engine 404 sends the transaction to and from the transformation engine 406 for translation, validation, and formatting. A state machine and billing engine 416 monitors the movement and history of each transaction as it is processed by the embodiment 400.

The transformation engine 406 may handle the actual conversion of data from one format and language to a second format and language. The transformation engine 406 may use XML and XSL and/or other methods of conversion. In addition, the transformation engine 406 may validate the data and prepare the data in a specific format. The transformation engine 406 may use data from schemata database 418, a validation database 420, and a presentation database 422.

The transformation engine 406 may validate the data prior to transformation. For example, the data may be scanned for viruses, the data may be checked for completeness, the data may be evaluated for accuracy, and other checks or evaluations of the data may be performed. The data may be checked for completeness by calculating a checksum and comparing the transmitted checksum to the calculated checksum. Other checks for completeness may include verifying that the required fields are present, or any other check as required. The routines and verification data for validation may be stored in the validation database 420. The transformation engine 406 may perform additional validation on the data after the actual transformation process.

The transformation engine 406 may transform data from one format and language to another. Such transformations may occur by using XSL translators and specific schemata for the particular translation. In some instances, the data to be translated may be both presented and requested in XML. In such instances, an appropriate XSL schema may complete the transformation. In other instances, the data may be converted to or from XML. In still other instances, the data may not be converted to XML at all, and may be transformed using conventional translators.

In some instances, data transformation may not be complete using conventional XSL transformations. For example, if data for zip codes were supplied in the conventional five-digit format, and the data were to be converted into the zip+5 format, a special routine may be used to find the zip+5 zip codes by comparing the addresses to a database of zip+5 zip codes. Such a routine may be used in addition to an XSL transformation.

The schemata database 418 is a repository of the available schema used for various applications. Such schemata may be schemata in the public domain, may be standard schemata supplied by the various application vendors who wish to interface with XDS, or may be custom written for the specific application.

The transformation engine 406 may present the transformed data in a specific format. Such formats may be stored in the presentation database 422 and control the look and feel of the documents as they are displayed. For example, the data may be transformed in XML, but the presentation of the data may be in HTML format using a specific style sheet. The style sheet may be stored in the presentation database 422.

The process engine 404 may handle the transportation, preprocessing, and post processing of the data as it is handled through the embodiment 400. Routines and functions available to the process engine 404 may be stored in the process database 426.

The transportation functions of the process engine 404 may include all of the incoming and outgoing communication functions with the requester 408 and responder 410. For example, the process engine 404 may include a listener that monitors an input port and receives a transaction to process. The process engine 404 may likewise prepare and transmit a transaction to a recipient using the appropriate protocol. Protocols may include transmission via the internet or other computer network, but may also include other methods of communication including a fax transmittal, voice messaging, pager alerts, preparing a letter to be mailed, or any other methods of communications.

The preprocessing and post processing functions of the process engine 404 may include any function required to prepare the transaction for transformation. These tasks may include authentication of the transaction, decryption or encryption of the transaction, and any other processing steps required for the preparation of the transaction. Immediately after receiving the transaction, the process engine may authenticate the incoming transaction as having originated at a certain computer, check the user against a lookup table of acceptable users, verify that the user has the privileges for the user's request, verify the user's password, verify that the proper software version was used for a particular function, or any other method for verifying that the user's identity and verifying the user's privilege to perform the requested actions. The process engine 404 may also decrypt incoming messages and encrypt outgoing messages using any form of encryption technologies.

The rules engine 402 may communicate with the rules database 424 to define the actions to be taken for a specific transaction. The rules database 424 may interface to schemata database 418, validation database 420, presentation database 422 as well as process database 426.

The rules engine 402 may determine all of the appropriate actions for a specific transaction, and then consolidate or aggregate the actions to be taken. For example, the rules engine may look up the applicable rules for a transaction. In the example, the rules may refer to the appropriate workflow, schemata, verification routine, billing information, and a style sheet for presentation. The transaction may then be assembled with the appropriate schemata, additional verification routines, and presentation routines and sent through the transformation engine and process engine.

In some cases, a relocatable transformation engine 412 or 414 may be used before the process engine 404. The relocatable transformation engine 412 or 414 may be a client application that runs on the computer system of the requester or responder, respectively. The relocatable transformation engine may be a client on the computer that generates the request. In other embodiments, the relocatable transformation engine may be resident on a computer attached to the requestor's computer via a local area network. In such an embodiment, the relocatable transformation engine may reside on a corporate firewall, for example.

The function of the relocatable transformation engine may be to offload a central server running XDS from the time consuming tasks of transformations. In addition, the relocatable transformation engine may transform the request or response into a smaller package for transportation, thus minimizing the communication bandwidth required.

The relocatable transformation engines 412 and 414 are connected to schemata, validation, and presentation databases 428 and 430, respectively. The databases 428 and 430 may be subsets of the main schemata database 418, validation database 420, and presentation database 422.

The relocatable transformation engine may be transparent to the user. For example, the XDS may send a schema to the requestor's computer and have the transaction come to the XDS partially or totally transformed. The XDS may move schemata or other items to the client automatically or manually. In the manual method, the business arrangement between the XDS provider and the requestor or responder may be such that some processing is done on a client. In the automatic method, the XDS may have a program that monitors the XDS workload and transfers some transformation, validation, or presentation processes to the client without the client's express knowledge.

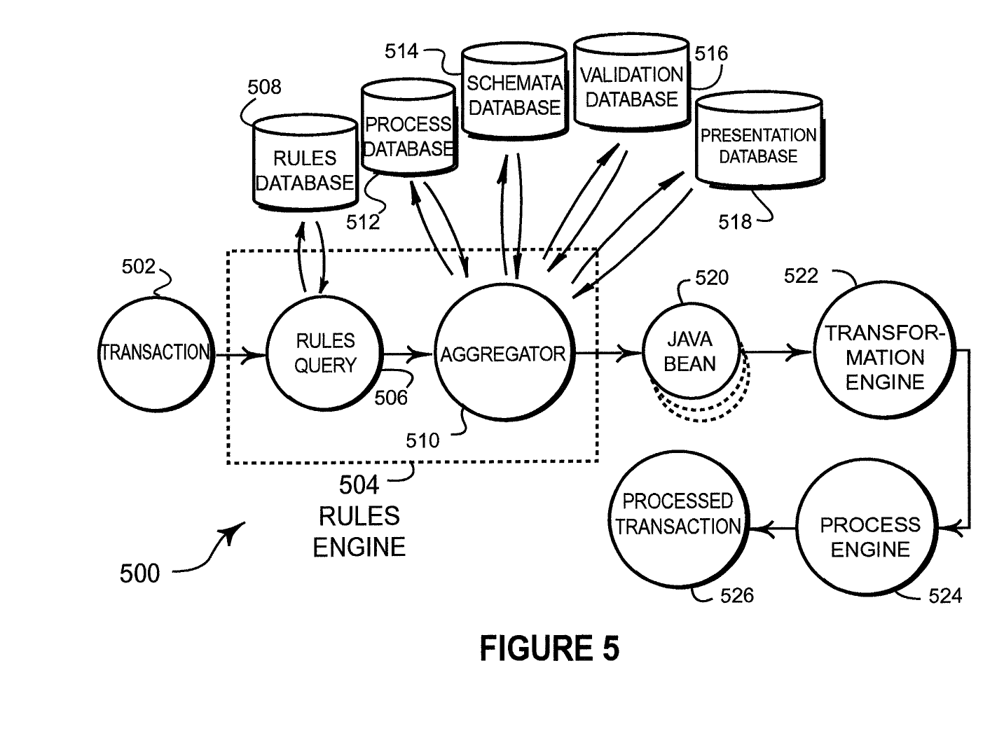

FIG. 5 illustrates the basic process of an embodiment 500 for processing a transaction 502 after it has been received and authenticated by the process engine. The transaction 502 enters the rules engine 504 that performs a rules query 506 to the rules database 508. The aggregator 510 queries the process database 512, the schema database 514, the validation database 516, and the presentation database 518. The aggregator 510 consolidates the transaction and database queries into one or more JavaBeans 520, which are then acted upon by the transformation engine 522 and the process engine 524 to yield a processed transaction 526.

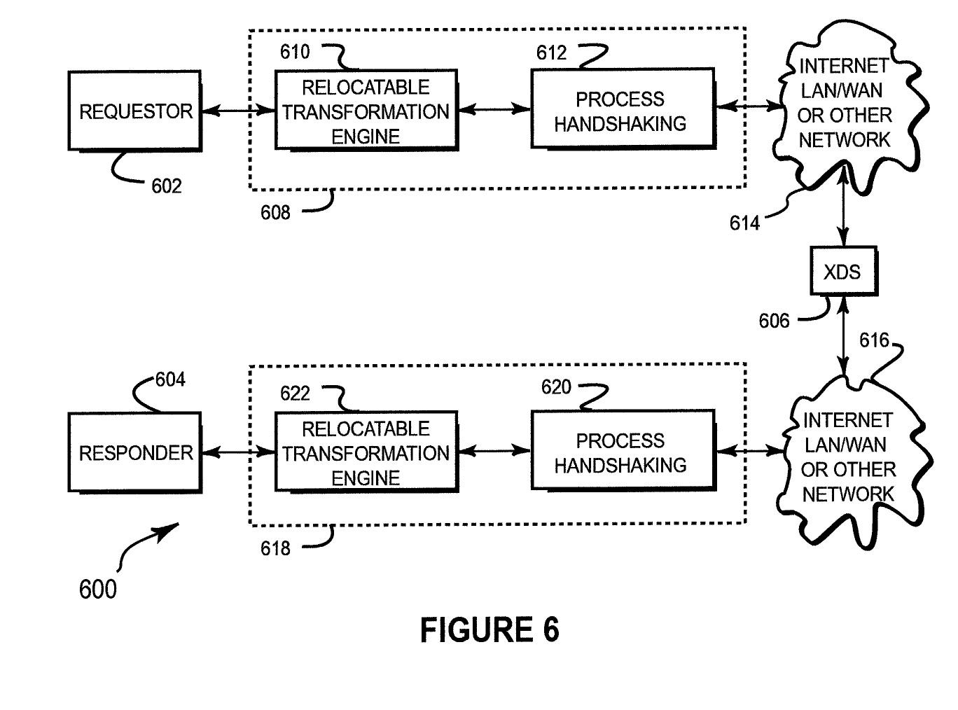

FIG. 6 illustrates an embodiment 600 of the relocatable transformation engines. In embodiment 600, the requestor 602 and responder 604 communicate through the XDS 606. The requester 602 communicates with the client 608 that contains the relocatable transformation engine 610 and a process handshaking module 612. The client 608 then communicates to the XDS server 606 through the internet, LAN/WAN, or other network 614. The XDS server 606 communicates through the network 616 to the responder client 618. The responder client comprises the process handshaking module 620 and the relocatable transformation engine 622.

The clients 608 and 618 may be clients that operate on the computers of the respective requester 602 and responder 604, the clients may reside on a firewall, or the clients may reside on another computer connected to the requestor's 602 and responder's 604 computer.

The process handshaking modules 612 and 620 may handle specialized communication protocols to the XDS server 606. Such protocols may require the encryption of the messages to be sent, special packetizing, labeling, or preparation of the transaction prior to transmission, logging of the transmission, or any other preparatory functions for transmission.

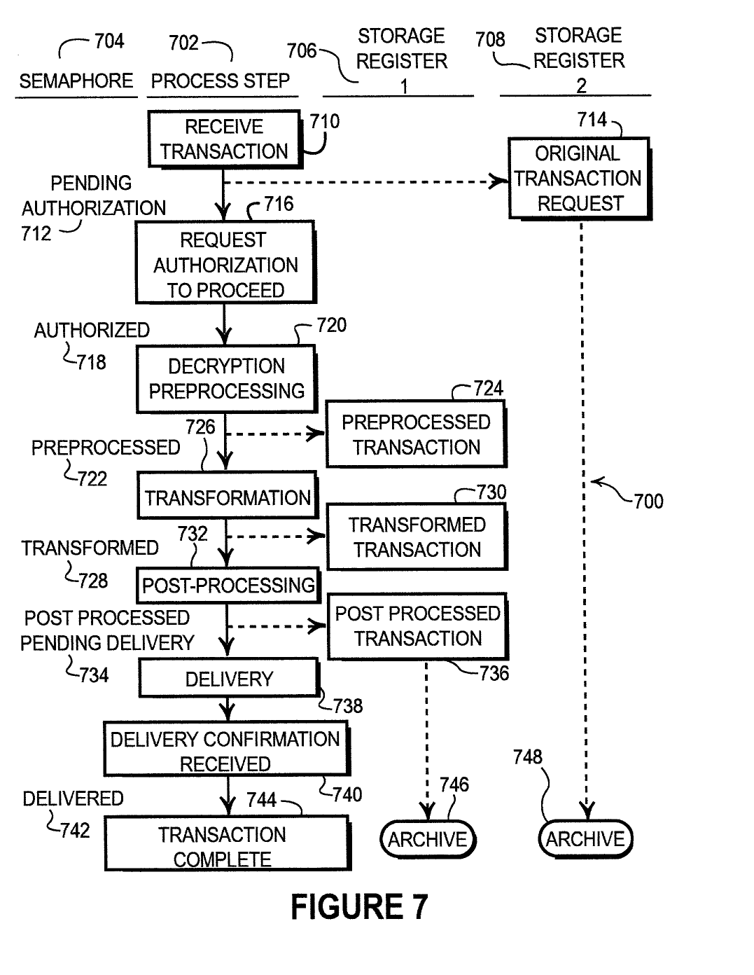

FIG. 7 illustrates an embodiment 700 of a method for tracking the state of a transaction through the XDS for the purposes of error recovery and restarting the system. The process step column 702 represents the steps through which a transaction may follow in a simple example. The semaphore column 704 contains the various semaphores or states of the transaction as it completes its journey. The storage register 1 column 706 represents the contents of the first storage register. The storage register 2 column 708 represents the contents of the second storage register.

The transaction is received from the sending computer in block 710, the semaphore is set to pending authorization 712, and the contents of the transaction are stored in the second storage register in block 714. The original transaction is kept stored while the transaction is being processed so that in the event of a validation error the original transaction may be restarted from scratch. In addition, the original transaction can be restarted if a power failure or other catastrophic failure should occur.

After the transaction is stored in its original form, a confirmation may be sent to the transmitting computer acknowledging the successful reception and storage. This handoff allows the sending computer system to assume that the XDS has ownership and control of the transaction. The sending computer may log the transaction as being processed.

After the request for authorization 716, the semaphore is set to authorized 718. At this state, the transaction has been authorized to proceed with transformation.

The decryption and preprocessing 720 then leads to the semaphore being set to preprocessed 722 and the results of the preprocessed transaction being stored in the first storage register 724. When the data are stored into the storage registers 706 and 708, the data may be verified prior to storage. Such verification may be a checksum, validation that the proper fields are present in the dataset, or may involve more complicated processing and checking prior to storage. If the data fails a verification step, the current process step may be rerun. If the data fails a subsequent time, the entire process may be restarted from the original transaction stored in the second storage register 714.

After transformation 726, the semaphore is set to transformed 728 and the transformed transaction is stored in the first storage register 730.

The post processing 732 then causes the semaphore to be changed to post processed/pending delivery 734 and the post processed transaction being stored in the first storage register 736.

The transaction is delivered 738 and a delivery confirmation received 740 so that the semaphore can be set to delivered 742 and the transaction completed 744, after which the contents of the first storage register are archived 746 as well as that of the second storage register 748.

At any time during the course of processing the transaction, the XDS may be able to recover from a disaster, such as a power failure, using the transactions stored in the first or second storage registers. If a power failure were to occur in the middle of the transformation step 726, when XDS would restart, the semaphore would be checked to see that the data in the first storage register had been preprocessed, and XDS would attempt to continue with the transformation 726 using the stored data. Should the transformation 726 fail, or the data were corrupt, XDS would then use the original stored transaction in the second storage register 714 and restart the transaction from the beginning.

The embodiment 700 is a method for keeping track of a transaction for disaster recovery and for ensuring that the transaction was properly executed. Each transaction in a business-critical setting, such as where the XDS may be used, may have a severe financial impact if a single transaction were lost or handled incorrectly. A method for guaranteeing the completion of each transaction may be an important feature for using a system for interchanging data between two separate entities. When transactions are used between companies, the data are assumed to be in two different places, i.e., at each company's location and those data are presumed to be the same. Should a transaction fail to be successfully transformed and delivered to its destination, the sender may assume that the transaction was logged by the intended recipient while the recipient has no knowledge of it. Such an example may lead to many dollars of missed revenue or opportunity.

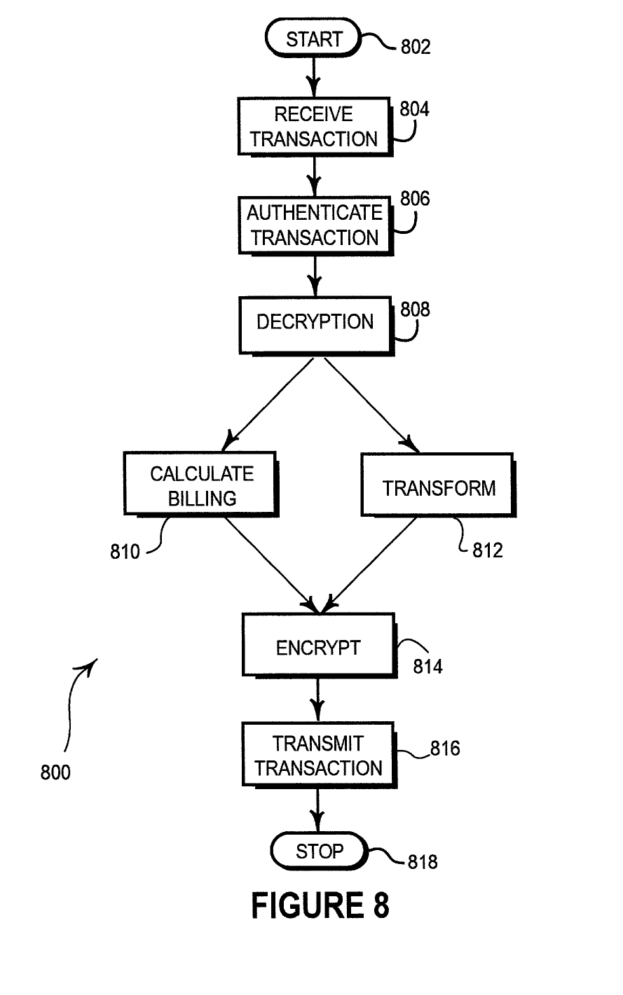

FIG. 8 illustrates a workflow 800 for an example simple transformation transaction. Such a workflow may be used for the transmission and transformation of a block of data from one company to another. For example, a first company may be sending an invoice to a second company through the XDS. The workflow starts in step 802. The transaction is first received step 804 and authenticated step 806. After decryption step 808, the workflow splits into the billing calculations step 810 and the transformation step 812. When both the billing step 810 and transformation step 812 are completed, the transaction is encrypted step 814 and transmitted step 816 before the workflow stops step 818. The workflow 800 illustrates a typical process for the inventive XDS, as well as illustrates the parallel paths of billing step 810 and transformation step 812.

The billing calculation step 810 refers to one method whereby the purveyors of the XDS may collect their revenues. In the present example, the engagement between the two companies may be such that the XDS application provider collects a certain percentage of all invoices as a payment for the use of the XDS system. In the billing calculation step 810, the amount of the invoice may be determined and the percentage applied to calculate the actual amount of money billed to one or both companies using the XDS for the present transaction. In other embodiments, one or both companies may pay a fixed fee for the XDS service. In other embodiments, one or both companies may use a recurring monthly fee based on the number of transactions or any other way of calculating a fee for the XDS service.

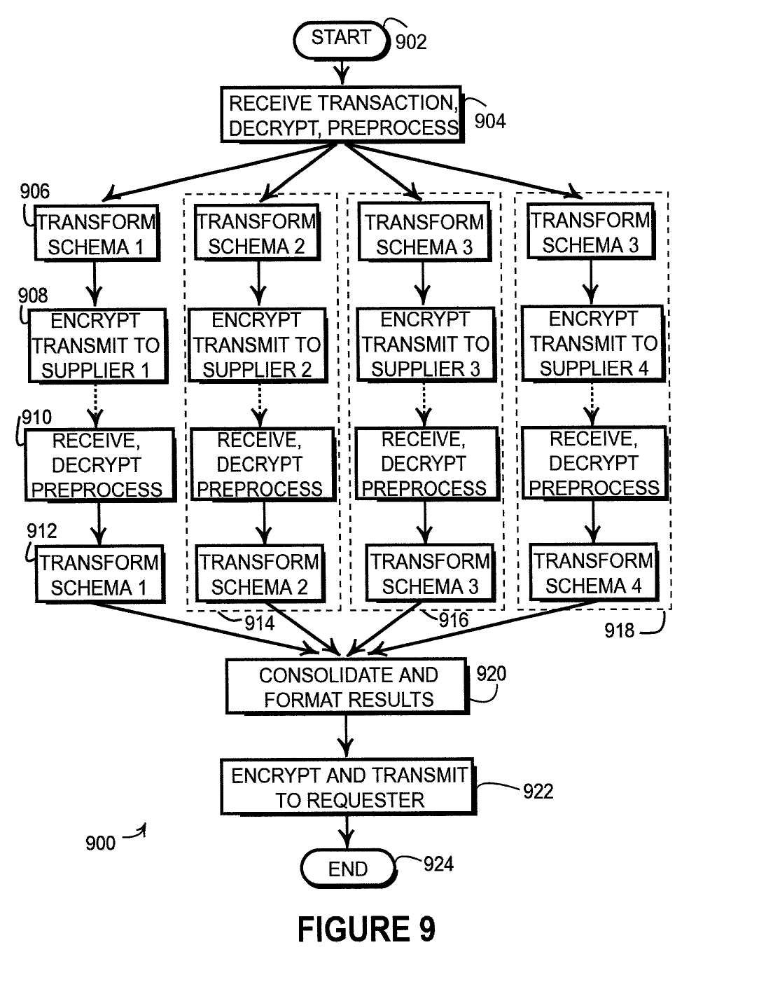

FIG. 9 illustrates a more complex XDS workflow 900 for an example transaction involving several companies. In the workflow 900, the requestor may solicit and receive a quotation from four companies. The companies may be suppliers, similar to the embodiment 300 as described heretofore.

The start step 902 of the transaction begins when the transaction is received, decrypted, and preprocessed step 904. In this case, the transaction will be transformed and sent to four different suppliers. For the first company, the transaction is transformed step 906, encrypted and transmitted to the first supplier step 908. When the first supplier responds, the transaction is received, decrypted, and preprocessed step 910 and transformed step 912 back into the original language and syntax for the requester company. The transaction is simultaneously transformed, transmitted, processed, received, and transformed again for the three other suppliers in steps 914, 916, and 918. When the results are received and transformed, they are consolidated and formatted step 920 and transmitted to the requestor step 922 to end the process step 924.

The workflow 900 illustrates a workflow wherein several companies interface with the XDS system. In the example workflow 900, the XDS system manages the communication between many companies and consolidates the results for the requester. In some cases, the requester may not know how many or which companies are contacted to satisfy the request.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for transforming and transporting financial transaction data between a first computer system and a second computer system comprising:
transforming said data using a first client application on said first computer system;
preparing a transaction using said first computer system, said transaction comprising said data;
transporting said transaction to a server computer;
processing said data on said server computer;
preparing said transaction using said server computer system;
transporting said transaction to said second computer system; and
transforming said data using a second client application on said second computer system.

2. The method of claim 1 wherein said step of preparing said transaction using said first computer system further comprises encrypting said data.

3. The method of claim 1 wherein said step of preparing said transaction using said server computer system further comprises encrypting said data.

4. The method of claim 1 wherein said step of processing said data on said server computer further comprises transforming said data.

5. The method of claim 1 wherein said processing said data on said server computer comprises determining the value of said financial transaction and multiplying said value by a percentage to calculate a fee.

6. A method of computing a fee for a transformation service performed on a financial transaction comprising:
receiving a transaction from a first client computer system by a server computer system, said transaction comprising data to be transformed, said data comprising at least one financial transaction;
transforming said data on said server computer system;
processing said data to determine a value of said financial transaction and multiplying said value by a percentage to determine a fee for said transformation, said processing being performed on said server computer system; and
transporting said data to a second client computer system.

7. A data switch system for the transformation of a transaction comprising:
a first client computer system having a first client application and being connected to a communications network and capable of transmitting a transaction, said first client application being capable of transforming said transaction at least partially with respect to a first schema;
a server computer connected to said communications network, said server computer being capable of receiving and sending said transaction, said server being further capable of transforming said transaction at least partially with respect to a second schema; and
a second client computer system having a second client application and being connected to a communications network and capable of receiving said transaction, said second client application being capable of transforming said transaction at least partially with respect to a third schema.

8. The data switch of claim 7 further comprising:
storage registers in said server computer for storing a transaction while said transaction is being processed by said server computer, said storage registers being capable of storing said transaction in the event of a power failure, said server computer being able to restart a transaction using said storage registers in the event of a power failure.
